(19) United States
(12) Patent Application Publication
(10) Pub. No.: US 2010/0249335 A1
(43) Pub. Date: Sep. 30, 2010

(54) Methods of producing zinc oxide polymer nanocomposites

(75) Inventors: Nobuo Miyatake, Pasadena, TX (US); Yuntao Li, Houston, TX (US); Hung-Jue Sue, College Station, TX (US); Katsumi Yamaguchi, Takasago (JP)

Correspondence Address: Attn: Jennifer S. Sickler;Gardere Wynne Sewell, LLP, 1000 Louisiana, Suite 3400, Houston, TX, 77002, US

(73) Assignees: Texas A&M University System, College Station, TX (US); Kaneka Corporation, Osaka (JP)

(21) Appl. No.: 12/802,164

(22) Filed: Jun. 1, 2010

Related U.S. Application Data
(62) Division of application No. 11/427,936, filed on Jun. 30, 2006.
Application No. 11/427,936 is a continuation-in-part of application No. 10/848,882, filed on May 19, 2004, now Pat. No. 7,482,382.
(60) Provisional application No. 60/696,413, filed on Jul. 1, 2005.

(51) Int. Cl. C08F 8/42

(52) U.S. Cl. 525/330.2; 525/333.3; 525/390

(57) ABSTRACT

A zinc oxide polymer nanocomposite composed of zinc oxide nanoparticles. The zinc oxide nanoparticles of the nanocomposite have an average particle size of about 1 nanometer to about 20 nanometers. Suitable polymers of the nanocomposites have less than about 500 ppm alkali metal. A process is provided for preparing the zinc oxide polymer nanocomposites comprising a) preparing a first combination comprising zinc oxide nanoparticles and a polymer; b) preparing a second combination comprising the first combination and an organic solvent; and c) precipitating the zinc oxide nanoparticles and the polymer out of the second combination. The zinc oxide nanoparticles of the first combination have an average particle size of between about 1 nanometer and about 20 nanometers.

### CROSS-REFERENCES TO RELATED APPLICATIONS

This Application is a divisional of U.S. patent application Ser. No. 11/427,936, filed on Jun. 30, 2006, entitled “Zinc Oxide Polymer Nanocomposites And Methods of Producing Zinc Oxide Polymer Nanocomposites,” which claims the benefit of U.S. Provisional Application Ser. No. 60/696,413, filed Jul. 1, 2005, entitled “Zinc Oxide Polymer Nanocomposites And Methods of Producing Zinc Oxide Polymer Nanocomposites,” and which is a continuation-in-part of U.S. application Ser. No. 10/848,882, filed May 19, 2004, entitled “Process for Preparing Nano-Sized Metal Oxide Particles.”

### STATEMENT REGARDING FEDERALLY SPONSORED RESEARCH OR DEVELOPMENT

### None.

### REFERENCE TO A SEQUENTIAL LISTING

### None.

### BACKGROUND OF THE INVENTION

1. Field of the Invention

The present invention relates to polymer nanocomposites comprising zinc oxide, and methods producing the same.

2. Background of the Art

Nanocrystalline-semiconductor particles have various uses. For example, U.S. Pat. No. 6,171,580 discloses the use of nano-sized particles in sunscreens and cosmetics as the active UV absorbing ingredient.

Particularly interesting materials include CdS, GaAs, GaN, Si, and ZnO. Recently, interest has grown in creating polymer nanocomposites, which are polymer composites containing zinc oxide nanoparticles.

M. Abdullah, et al. prepared ZnO-polymer nanocomposites using a high concentration of LiOH to generate strong luminescence intensity. J. Phys. Chem. B, 107, In Situ Synthesis of Polymer Nanocomposite Electrolytes Emitting a High Luminescence With a Tunable Wavelength, 1957-1961 (2003)). Accordingly, the polymer-isolated nanocomposites contained a significant amount of alkali metal.

P. Kofinas et al. discloses the formation of self-assembled ZnO nanoclusters using diblock copolymers. Solid-State Electronics, 46, Properties of self-assembled ZnO nanostructures, 1639-1642(2002)). The diblock copolymers consisted of a majority polymer (norbornene) and a minority polymer (norbornene-dicarboxcylic acid).

Japanese Patent Publication No. 11-217,511 to Toppan Printing Co. Ltd discloses the formation of a composite material comprising a polymer and an inorganic compound. The composite was produced by dispersing an inorganic compound having a particle diameter ranging from 5-400 nanometers in a polymeric compound.

Japanese Patent Publication No. 2003/147,090 to Mitsubishi Chem. Corp. discloses a molded article comprising a thermoplastic resin composition obtained by dispersing ultra fine particles having a number average particle diameter of from 0.5 to 50 nm, wherein the article has a thickness of less than or equal to 0.1 mm, a mean birefringence of less than or equal to 10 nm, and an optical path of 1 mm.

The inventors believe that if the zinc oxide polymer nanocomposite contains a large quantity of alkali metal, then certain properties of the zinc oxide polymer nanocomposite will be impaired. Additionally, the inventors believe that if the polymers used to create the zinc oxide polymer nanocomposite contain a relatively high quantity of carboxylic groups or sulfonyl groups, then certain properties of the zinc oxide polymer nanocomposite will be impaired. Such properties include, but are not limited to, appearance, moisture adsorption, optoelectronic emission efficiency, and thermal stability. Moreover, preferred zinc oxide polymer nanocomposites contain a narrow size distribution of nanoparticles. Accordingly, there is a need for zinc oxide polymer nanocomposites, which contain a narrow particle size distribution of zinc oxide nanoparticles, minimal alkali metal, and are made from a polymer, which contains a limited amount of functional-carboxylic-acid groups and functional-sulfonyl groups.

### BRIEF SUMMARY OF THE INVENTION

The present invention is directed to a novel polymer nanocomposite composed of zinc oxide nanoparticles and a polymer. More specifically, the zinc oxide nanoparticles have an average particle size of from about 1 nanometer to about 20 nanometers, and the polymer nanocomposite has less than about 500 ppm alkali metal.

The present invention further provides a process for the production of zinc oxide polymer nanocomposites. The process involves preparing a first combination of zinc oxide nanoparticles and a polymer, wherein the zinc oxide nanoparticles have an average particle size of between about 1 nanometer and about 20 nanometers. A second combination is prepared by combining the first combination and an organic solvent. The zinc oxide nanoparticles and the polymer are precipitated out of the second combination. The precipitates are isolated and dried to form a polymer nanocomposite.

### DETAILED DESCRIPTION OF THE INVENTION

### Synthesis of the Zinc Oxide Nanoparticle

The zinc oxide nanoparticles may be synthesized by a sol-gel method. In general, the sol-gel method is based on the transition of a system from a liquid sol into a solid gel phase. The liquid sol is a mostly colloidal suspension, which is a suspension of small particles in a liquid. The zinc oxide nanoparticles may be synthesized by reacting, under sol-gel conditions, a precursor with an alcohol-based solution using alkali metal hydroxide.

Reaction parameters generally include the pH, temperature, and pressure of the reaction. The pH of the reaction mixture may be at least about 7.0. Alternatively, the pH of the reaction mixture is between about 7.0 and about 10.5. During the reaction, the reaction temperature may be between about 10° C. and about 100° C. The reaction pressure may range from a vacuum to 2 MPa. Alternatively, the reaction pressure is atmospheric.

The zinc oxide nanoparticles may have a number-average particle size between about 1 nanometer and about 20 nanometers. Alternatively, the zinc oxide nanoparticles have a number-average particle size within the following ranges: between about 1 nanometer and about 15 nanometers; between about 1 nanometer and about 10 nanometers; between about 1 nanometer and about 5 nanometers; and between about 1 nanometer and about 4 nanometers. The zinc oxide nanoparticles may have a standard deviation in particle size distribution of at most about 5.0 nanometers, and alternatively at most about 3.0 nanometers. The inventors believe that preferred quantum confinement effects of the zinc oxide polymer nanocomposite diminish if the number-average particle size of the zinc oxide nanoparticles is too large, or the standard deviation in particle size distribution of the zinc oxide nanoparticles is too large, or if both are too large. Specifically, the preferred quantum confinement effects are that the zinc oxide nanosized particles have electronic bandgaps that are larger than that of corresponding bulk material, and these bandgaps can be fine tuned within the nanosized regime by changing and/or mixing the particle sizes.

The zinc oxide nanoparticles may be formed from a zinc oxide precursor. The zinc oxide precursor may be any compound that can be converted into zinc oxide by reaction. Suitable zinc oxide precursors include zinc halides selected from the group consisting of zinc acetate, zinc carboxylate, zinc dichloride, zinc nitrate, zinc oleate, and their respective hydrates.

The alcohol-based solution may be any solution that contains alcohol and less than about 50% by weight of the whole solution of a secondary component. Suitable alcohols include methanol, ethanol, propanol and 2-propanol. Suitable secondary components include water and organic solvents such as acetone, methylethylketone and tetrahydrofuran. Alternatively, the alcohol-based solution comprises an alcohol and less than about 30% by weight of the whole solution of a secondary component.

The inventors believe that the alkali metal hydroxide aids in converting the precursor into the nanoparticles. Suitable alkali metal hydroxides are selected from the group comprising lithium hydroxide, sodium hydroxide, potassium hydroxide, rubidium hydroxide, cesium hydroxide, and francium hydroxide.

### Suitable Polymers

Preferred polymers do not contain a significant amount of the following functional groups: carboxylic acid, carboxylic acid anhydride and sulfonyl. In an embodiment, the polymer contains less than about 0.0001 mol/kg—alternatively from about 0.00001 to about 0.0001 mol/kg—of each of the following functional groups: carboxylic acid, carboxylic acid anhydride and sulfonyl. In an alternative embodiment, the polymer contains less than 0.00001 mol/kg—alternatively from about 0.000001 to about 0.00001 mol/kg—of each of the following functional groups: carboxylic acid, carboxylic acid anhydride and sulfonyl. Acid-base titration and NMR are used to calculate the quantity of carboxylic acid groups, carboxylic acid anhydride groups and sulfonyl groups.

Additionally, preferred polymers have a number average molecular weight (Mn) of between about 5,000 and about 5,000,000. Alternatively, the Mn of the polymer ranges between about 10,000 and about 2,000,000, or between about 50,000 and about 1,000,000. The Mn of the polymer is measured by gel permeation chromatography with a calibration of standard polystyrenes.

Suitable polymers include (meth)acrylic resin such as polymethylmethacrylate, polybutylacrylate, methlymethacrylate-butylacrylate copolymer, and metylmethacrylate-styrene copolymer, styrenic resin such as polystyrene, styrene-acrylonitrile copolymer styrene-isobutyrene copolymer and styrene-butylacrylate copolymer, polycarbonate resin, polyester resin such as polyethylene terephalate and polybutylene terephthalate, epoxy resin such as bisphenol-A epoxy resin, bisphenol-F epoxy resin and epoxidized phenolic resin, phenylenevinylene resin such as poly(2-methoxy-5-ethylhexyloxy-1,4-phenylenevinylene), fluorene resin such as poly(9,9-di-(2-ethylhexyl)-fluorenyl2,7-diyl) and poly (9,9-dioctylfluorenyl-2,7-diyl), fluorenevinylene resin such as poly(9,9-dihexyifluorenyl-2,7-divinylene-fluorenylene) and poly(9,9-dihenyl2,7-(2-cyanodivinylene)-fluorenylene), phenylene resin such as poly(2,5-dioctyl-1,4-phenylene) and poly [2-(6-cyano-6-methlyheptyloxy)-1,4-phenylene], thiophene resin such as poly(3-hexylthiophene), and combinations thereof.

### Mixing the Zinc Oxide Nanoparticles and the Polymer

The polymer is preferably dissolved before the zinc oxide nanoparticles and polymer are mixed in an alcohol-based solution. Some polymers are soluble in the alcohol-based solution. In these cases, the zinc oxide nanoparticles and polymer may be added directly to the alcohol-based solution, wherein the polymer will dissolve and mix with the zinc oxide nanoparticles. However, in some situations the polymer is insolvent—or poorly solvent—in the alcohol-based solution. In these situations, an organic solvent is used to dissolve the polymer. The polymer may be dissolved in the organic solvent before it is added to the alcohol-based solution. Alternatively, the organic solvent can be added to the alcohol-based solution prior to the addition of the polymer and the zinc oxide nanoparticles. The amount of organic solvent used, by weight, must not exceed about eight times the weight of the alcohol-based solution. Suitable organic solvents include acetone, dichloromethane, methylethylketone, tetrahydrofuran.

### Precipitation

After the zinc oxide nanoparticles and the polymer are mixed, the combination may be poured into an organic solvent. The inventors believe that the organic solvent causes the zinc oxide nanoparticles and polymer to precipitate at approximately the same time. Suitable organic solvents include methanol, ethanol, propanol and combinations thereof. The inventors believe that the alkali metal is attracted to the organic solvent. Accordingly, a sufficient amount of organic solvent is used such that the amount of alkali metal in the precipitates is less than about 500 ppm. Alternatively, the amount of alkali metal in the precipitates ranges in the following amounts: less than about 200 ppm; less than about 100 ppm; from about 500 ppm to about 100 ppm; from about 200 ppm to about 50 ppm; and from about 100 ppm to about 1 ppm.

In some cases the zinc oxide nanoparticles precipitate less efficiently than the polymer. In these cases, a cationic emulsifier is added to the zinc oxide nanoparticle and polymer mixture before the mixture is added to the organic solvent. The inventors believe that if the zinc oxide nanoparticles precipitate less efficiently than the polymer, adding the cationic emulsifier to the mixture before the addition of organic solvent promotes the precipitation of the zinc oxide nanoparticles and ensures simultaneous precipitation. Suitable cationic emulsifiers are not particularly limited and include quaternary ammonium salts such as cetyltrimethylammomium bromide and dialkyldimethylammonium bromide. The amount of cationic emulsifier added is preferably between a 1:1 molar ratio of cationic emulsifier to metal of the nanoparticle to 20:1 molar ratio of cationic emulsifier to metal of the nanoparticle.

The precipitates can be isolated by means of centrifugation and decantation. The isolated precipitate is then dried.

### EXAMPLES

The following examples and comparative examples are provided to demonstrate particular embodiments of the present invention. It should be appreciated by those of skill in the art that the methods disclosed in the examples and comparative examples that follow merely represent exemplary embodiments of the present invention. Those of skill in the art should, in light of the present disclosure, appreciate that many changes can be made in the specific embodiments described and still obtain a like or similar result without departing from the spirit and scope of the present invention.

In the examples and comparative examples, measurements and evaluations were made as follows:

Average particle size of ZnO particles in an alcohol based solution: The following equation provided by Meulenkamp [E. A. Meulenkamp, J. Phys Chem. B, 102, 5566-5572 (1998)] was used to convert the measured values of λ_{1/2} (the wavelength at which the absorption is the half of that at the shoulder) into particle sizes based on the size determination result from TEM micrographs and XRD line broadening:

1240/λ_{1/2}=a+b/D²−c/D

where a=3.301, b=294.0 and c=−1.09; and, D is the diameter. The UV absorption was measured in UV-vis spectrophotometer (UV 1601) made by SHIMADZU CO.

Average particle size and particle size distribution of ZnO particles in the polymer nanocomposite: Transmission electron microscopy (TEM) was used to find the average particle size and the particle size distribution of ZnO particles dispersed within the polymer nanocomposites. TEM images were recorded using a JEOL JEM-1200EX instrument (80 kV). Heat-pressed samples were cut into ultra thin sections for use in the TEM. The TEM image analysis was conducted using more than 200 particles in the image with a magnification of 400,000.

Quantification of potassium in the polymer nanocomposites: The quantity of potassium was measured by elemental analysis. Elemental analysis was conducted in accordance with the following procedure: the samples were microwave digested using a 30-50 mg sample size and 10 ml of trace metal grade nitric acid. The digested samples were analyzed by inductively coupled plasma-mass spectrometry.

Thermal decomposition temperature: Thermal decomposition temperature was measured by thermogravimetry using a 1-2 mg sample size. The decomposition temperature is the point at which 20% of the sample weight was reduced.

### Example 1

79 grams of 0.28% KOH in methanol (alcohol-based solution) was prepared and heated at 60° C. with stirring. 0.44 grams (2 mmol) of Zn(OAc)*2H20 (zinc acetate dihydrate) powder was then added to this alcohol-based solution under reflux and stirring. The reaction stoichiometry of the zinc acetate dihydrate to the KOH in the reaction mixture was 1:2. After stirring continuously for 5 hours, the solution was cooled to 23° C. During the reaction, the pH of the solution was maintained at 7.0 or higher, and the final pH was 8.7. The product was a transparent sol having nano-sized ZnO with an average diameter of 3 nanometers (“product (1)”).

5.5 grams of 3.8% polymethylmethacrylate (PMMA) (Mn=85,400, without any carboxylic acid) in methylethylketone was prepared at room temperature. 0.7 grams of didodecyldimethylammonium bromide (DDAB) was added to the solution. The molar ratio of DDAB:Zn was 10:1. 6.0 grams of the product (1) was dissolved in the solution. The solution obtained (“solution (1)”) was held at room temperature for 3 hours. Then solution (1) was poured into 60 grams of methanol. The precipitates produced shortly, and this system was held for 3 hours to complete the precipitation. After that, the precipitates were isolated from the system by centrifugation, and dried at 60° C. for 5 hours. FT-IR was used to show that the isolated precipitates (“composite (1)”) were composed of PMMA and ZnO. FT-IR also showed that DPAB was eliminated from composite (1). Elemental analysis was used to confirm that composite (1) contained 200 ppm potassium. The thermal decomposition temperature was 388° C. Heat press at 180° C. of composite (1) gave a transparent film that shows green emission under the exposure of UV (365 nanometers). The average particle size and particle size distribution of ZnO in the heat press was 6 nanometers and 1 nanometer, respectively.

### Example 2

In Example 2, composite (2) was prepared in the same manner as in Example 1, except that DDAB was not used in Example 2. FT-IR was used to detect the ZnO in composite (2). The absorption peak of Zn—O was lower in composite (2) than it was in composite (1). Elemental analysis indicated that composite (2) contained 190 ppm potassium. The thermal decomposition temperature was 385° C. Heat press at 180° C. of composite (2) gave a transparent film that shows green emission under the exposure of UV (365 nm). The average particle size and particle size distribution of ZnO in the heat press sample were 6 nanometers and 1.6 nanometers, respectively.

### Comparative Example 1

In Comparative Example 1, composite (1)′ was obtained by removing the solvents from solution (1) in Example 1 using a rotary evaporator. FT-IR showed that composite (1)′ was composed of PMMA and ZnO. Elemental analysis was used to show that composite (1)′ contained 50,000 ppm potassium. The thermal decomposition temperature was 364° C. Heat press at 180° C. of composite (1)′ gave an opaque film with a rough surface.

### Example 3

6.0 grams of 4.7% polystyrene (PSt) (Mn=155,000, without any carboxylic acid) in tetrahydrofuran was prepared at room temperature. 3.0 grams of product (1) was dissolved into the solution of PSt and tetrahydrofuran. The solution obtained (“solution (2)”) was held at room temperature for 3 hours. Then solution (2) was poured into 60 grams of methanol. The precipitates produced shortly, and this system was held for 3 hours to complete the precipitation. After that, the precipitates were isolated from the system by centrifugation and dried at 60° C. for 5 hours. FT-IR showed that the isolated precipitates (“composite (3)”) were composed of PSt and ZnO. Elemental analysis was used to show that composite (3) contained 150 ppm potassium. Heat press at 180° C. of composite (3) gave a transparent film that shows green emission under the exposure of UV (365 nanometers). The average particle size and particle size distribution of ZnO in the heat press sample was 5 nanometers and 1.3 nanometers, respectively.

### Example 4

9.3 grams of 1.4% poly(bisphenol-A carbonate) (PC) (Mn=22000, without any carboxylic acid) in dichloromethane was prepared at room temperature. 1.4 grams of product (1) prepared was dissolved into the solution of PC and dichloromethane. The solution obtained (“solution (3)”) was held at room temperature for 3 hours. Then solution (3) was poured into 60 grams of methanol. The precipitates produced shortly, and this system was held for 3 hours to complete the precipitation. After that, the precipitates were isolated from the system by centrifugation and dried at 60° C. for 5 hours. FT-IR showed that the isolated precipitates (“composite (4)”) were composed of PC and ZnO. Elemental analysis was used to show that composite (4) contained 150 ppm potassium. Heat press at 220° C. of composite (4) gave a transparent film that shows green emission under the exposure of UV (365 nanometers). The average particle size and particle size distribution of ZnO in the heat press sample was 5 nanometers and 1.5 nanometers, respectively.

1. A process comprising the steps of:
a) preparing a first combination comprising zinc oxide nanoparticles and a polymer, wherein the zinc oxide nanoparticles have an average particle size of between about 1 nanometer and about 20 nanometers;
b) preparing a second combination comprising the first combination and an organic solvent; and
c) precipitating the zinc oxide nanoparticles and the polymer out of the second combination.

2. The process of claim 1, wherein the zinc oxide nanoparticles are prepared by a process comprising the steps of reacting a precursor with an alcohol-based solution using an alkali metal hydroxide.

3. The process of claim 2, wherein the precursor is selected from the group consisting of zinc acetate, zinc carboxylate, zinc dichloride, zinc nitrate, zinc oleate, and hydrates thereof.

4. The process of claim 2, wherein the alcohol-based solution comprises an alcohol selected from the group consisting of methanol, ethanol, propanol, and 2-propanol and a secondary component selected from the group consisting of water, acetone, methyletlyketone, and tertahydrofuran.

5. The process of claim 4, wherein the secondary component is less than 30 percent by weight of the whole solution.

6. The process of claim 2, wherein the alkali metal hydroxide is selected from the group consisting of lithium hydroxide, sodium hydroxide, potassium hydroxide, rubidium hydroxide, cesium hydroxide, and francium hydroxide.

7. The process of claim 1, wherein the first combination comprises zinc oxide nanoparticles and a dissolved polymer.

8. The process of claim 7, wherein first combination further comprises a dissolving-organic solvent.

9. The process of claim 1, wherein the process further comprises:
a) preparing a solution comprising a dissolving-organic solvent and the polymer before preparing the first combination.

10. The process of claim 7, wherein the dissolving-organic solvent is selected from the group consisting of acetone, dichloromethane, methylethylketone, and tetrahydrofuran.

11. The process of claim 10, wherein the weight of dissolving-organic solvent is less than eight times the weight of the alcohol-based solution.

12. The process of claim 2, wherein the organic solvent is selected from the group consisting of methanol, ethanol, propanol, and combinations thereof.

13. The process of claim 2, wherein a sufficient amount of organic solvent is added such that precipitates contain less than about 500 ppm alkali metal.

14. The process of claim 1, wherein the first combination comprises the nanoparticles, the polymer and a cationic emulsifier.

15. The process of claim 14, wherein the cationic emulsifier is a quaternary ammonium salt.

16. The process of claim 15, wherein the quaternary ammonium salt is selected from the group consisting of cetyltrimethylammomium bromide and dialkyldimethylammonium bromide.

17. The process of claim 14, wherein the molar ratio of cationic emulsifier to the metal of the nanoparticle ranges from 1:1 to 20:1.

18. The process of claim 1, further comprising the steps of:
a) isolating the precipitates; and
b) drying the precipitates.
